(19) United States
(12) Patent Application Publication
(10) Pub. No.: US 2007/0034433 A1
(43) Pub. Date: Feb. 15, 2007

(54) Remote vehicle safety device

(76) Inventor: John Gabriele, Shavertown, PA (US)

Correspondence Address: L. ZALE PATENT LAW OFFICE, 334 SOUTH FRANKLIN ST., WILKES-BARRE, PA, 18702, US

(21) Appl. No.: 11/501,453

(22) Filed: Aug. 8, 2006

Related U.S. Application Data
(60) Provisional application No. 60/707,130, filed on Aug. 9, 2005.

(51) Int. Cl. B60T 7/16

(52) U.S. Cl. 180/167; 318/16; 340/825.69

(57) ABSTRACT

A remote vehicle safety system for use with a child-operated riding vehicle (100) employs a portable remote control (50) operated by a user, having a transmitter (57) for transmitting a signal to a receiver (107) on the vehicle (100). The receiver recognizes the signal from the transmitter (57). The receiver (107) then operates an actuator (211) causing a modification circuit (109) to modify power being provided to a motor (103) on vehicle (100). It may slow or stop the vehicle (100) preventing a child rider from getting into a dangerous situation.

### CROSS REFERENCE TO RELATED APPLICATIONS

This patent application claims priority from US. Provisional Patent Application 60/707,130 filed Aug. 9, 2005.

### BACKGROUND OF THE INVENTION

1. Field of the Invention

The present invention relates to a safety device which controls riding vehicles from a remote location.

2. Discussion of Related Art

Riding vehicles, such as electric toy cars and motorized scooters intended to be used by children and adolescents are rapidly advancing in technology. With the advent of new battery technology and high efficiency electric motors, these vehicles may outpace a running parent. Since the children riding these vehicles do not have a great appreciation for danger, it is possible that they may wander into the path of an oncoming car or drive off an embankment.

There have been attempts to provide safety devices to protect children against these dangers and similar problems. For example, U.S. Pat. No. 4,785,291 describes a monitoring device that notifies a parent when a child moves beyond a predetermined distance from the device. It then sends an audible alert to the parents/guardians. This is designed to warn of danger, but unfortunately does not to stop the potential injury from occurring.

There have been other attempts to remotely disable motorboats; however these were designed only to stop a gasoline-powered engine. This invention does not operate as well on electric-powered vehicles.

Other devices are known which stop the vehicle motor in the event that the vehicle is out of control. These are operated locally by the rider and cannot be operated remotely. These have obvious problems since the parent or guardian cannot activate the device from a remote location.

Currently, there is a need for a safety system to remotely control a child's vehicle from a remote location to prevent injury, which does not diminish the functionality of the vehicle.

### SUMMARY OF THE INVENTION

One embodiment of the present invention is A remote safety system (1) for use with a riding vehicle (100) having a battery (101) for providing power to a motor (103), said system having:
a) at least one transmitter (57) for transmitting a signal, the transmitter (57) being part of a portable remote control (50);
b) a receiver (107) for receiving and recognizing the signal from the transmitter (57),
c) A modification circuit (109) capable of modifying power being provided from the battery (101) to the motor (103), thereby affecting said vehicle's (100) operation;
d) An actuator (211), responsive to the receiver (107), for causing the modification circuit (109) to modify power being provided to motor (103) when the receiver (107) receives a modification signal.
The invention also may be considered a method of protecting a rider on a riding vehicle (100) having a battery (101) powering a motor (103) through a switch (105) comprising the steps of:
   a) providing a modification circuit (109) capable of restricting power supplied from said battery (101) to said motor (103);
   b) providing a receiver (107) capable of receiving and recognizing at least one transmitted signal, and capable of operating said modification circuit (109) causing the modification circuit (109) to modify the amount of power supplied to said motor (103) when the modification signal is received; and
   c) operating a remote transmitter (57) to transmit a modification signal to the receiver (107) causing receiver (107) to operate modification circuit (109) thereby modifying the power provided to motor (103).
The present invention may also be embodied as a method of retrofitting a riding vehicle (100) having a battery (101) powering a motor (103) through a switch (105) for protecting a rider comprising the steps of:
   a) adding a modification circuit (109) to said riding vehicle (100) capable of restricting power supplied from said battery (101) to said motor (103);
   b) adding a receiver (107) to said riding vehicle (100) capable of receiving and recognizing at least one transmitted signal, and capable of operating said modification circuit (109) causing the modification circuit (109) to modify the amount of power supplied to said motor (103) when the modification signal is received; and
   c) operating a remote transmitter (57) to transmit a modification signal to the receiver (107) causing receiver (107) to operate modification circuit (109) thereby modifying the power provided to motor (103).

### OBJECTS OF THE INVENTION

It is another object of the present invention to provide a system for remotely stopping a child's vehicle to prevent injury.

It is another object of the present invention to provide a system for remotely slowing a child's vehicle to prevent injury.

It is an object of the present invention to provide a low-drain safety cut-off switch for electric riding vehicles which may be remotely operated.

### BRIEF DESCRIPTION OF THE DRAWINGS

The advantages of the instant disclosure will become more apparent when read with the specification and the drawings, wherein:

FIG. 1 is a perspective view of a child's vehicle and a transmitter according to one embodiment of the present invention.

FIG. 2 is a schematic circuit diagram of one embodiment of the present invention.

### DETAILED DESCRIPTION OF THE INVENTION

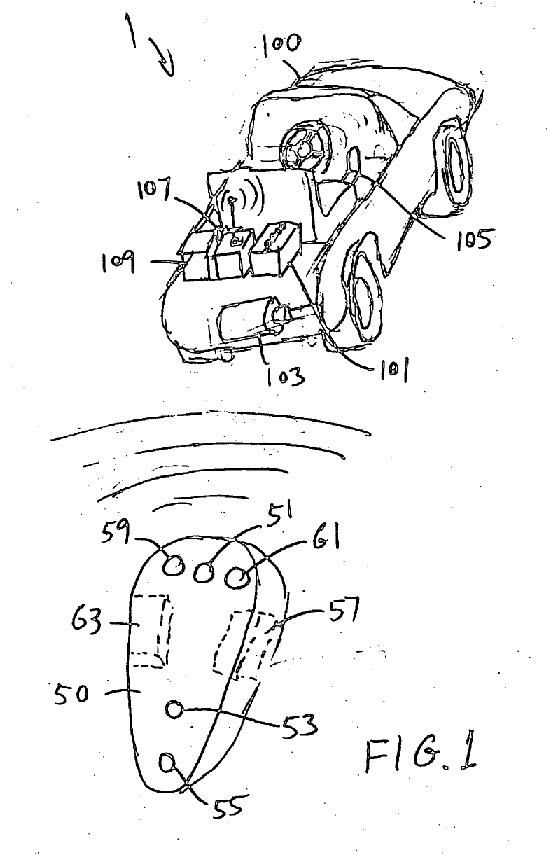

FIG. 1 is a perspective view of one embodiment of the remote vehicle safety device 1 according to the present invention. A vehicle 100, intended to be ridden by a child or adolescent, is shown. Vehicle 100 is the type which is designed for a child to sit on and operate the pedals to drive the vehicle 100. Vehicle 100 includes a self-contained battery 101 powering an electric motor 103. Battery 101 is typically a deep cycle, high-energy rechargeable battery.

Vehicle 100 includes a switch (accelerator pedal) 105 which is a switch completing a circuit between battery 101 and motor 103. Pedal 105 may also be a variable resistor or current splitter, causing some degree of current to flow to motor 103, thereby allowing variable acceleration from a standing stop.

As a child riding vehicle 100 begins to stray away or begins to approach a dangerous location, a user, which is typically a parent or guardian, presses a button 51 on a remote control 50. This activates a remote transmitter 57 to send a signal to a receiver 107 located on vehicle 100.

Receiver 107 receives the signal and determines (decodes) which of the several possible signals is being received. Receiver 107 then interacts with a modification circuit 109 to modify the maximum power running to motor 103, thereby slowing, or stopping vehicle 100, upon a ‘slow’ or ‘stop’ signal being received, respectively.

In one embodiment of the present invention, the receiver circuit is only powered when accelerator 105 is pressed. Therefore, it does not drain electric energy from battery 101 when the vehicle is not being driven.

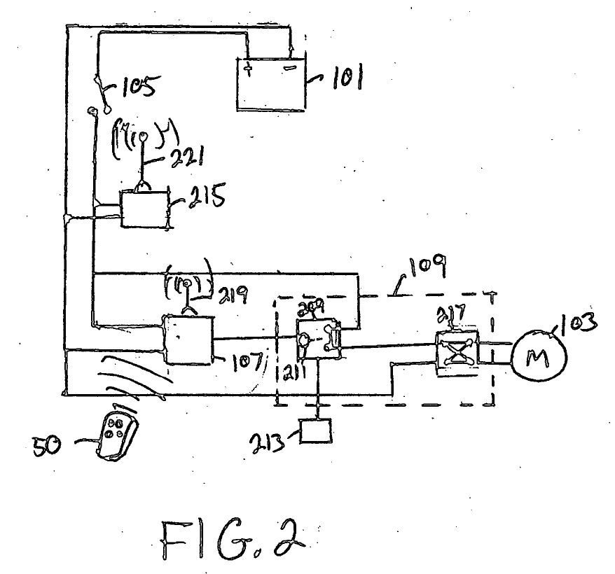

Based upon experiments of a prototype, it was determined that when receiver 107 is in its idle mode (not receiving a signal) it draws approximately 50 MA. When receiver 107 is actively receiving and deciphering a signal, it draws approximately 260 MA. In FIG. 2, a relay 209 is used in the modification circuit 109. It was determined that relay 209 draws approximately 70 MA. Therefore, with both receiver 107 and relay 209 being active, approximately 325 MA of current are drawn from battery 101. Therefore, this circuit design extends the life of battery 101 as compared with other designs which are active most of the time. Please note that these numbers vary depending upon the actual receiver and relays used.

Modification circuit 109 employs a toggle switch which continues to modify power delivered to motor 103 until the user presses a reset button 53 which re-activates normal operation of motor 103.

Optionally, there may be a distance transmitter 215 attached to vehicle 100 which transmits a signal through an antenna 221. The signal from distance transmitter 215 is received by a distance receiver 63 in remote control 50. Distance receiver 63 determines the signal strength coming from distance transmitter 215 and determines if it is within range for receiver 107 to receive signals from transmitter 57. If so, an indicator light 55 is illuminated on remote control 50. This indicates when remote control 50 is in range to deactivate vehicle 100.

In other optional embodiments, there may be additional controls, such as a ‘slow’ button 61 on remote control 50 which may cause current limitations which will decrease the maximum power sent to motor 103, thereby reducing the speed of vehicle 100 significantly.

FIG. 2 is a schematic circuit diagram of the embodiment of the present invention shown in FIG. 1. Battery 101 is shown connected to the circuit through switch 105. Receiver 107 receives a signal through its antenna 219 and operates modification circuit 109. Modification circuit 109 in this embodiment is comprised of a relay 209 and an actuator 211. Actuator 211 is responsive to receiver 107 and causes relay 209 to be in the closed (operate) mode when the ‘stop’ signal is received from transmitter 57 (when deactivation button 51 is pressed on remote control 50).

Actuator 211 causes relay 209 to be in an open (do not operate) mode when it receives the ‘stop’ signal. Since this is a latching relay, it is designed to keep its current state upon powering down. There is no change of state when switch (foot pedal) 105 changes position.

Modification circuit 109 may employ a variable current limiting or voltage limiting device 217 in an alternative embodiment, which will slow vehicle 100 when a ‘slow’ signal is received from transmitter 50.

Therefore, the present invention provides a remotely operated safety device which is adapted for use on children's vehicles, for deactivating the vehicle thereby protecting them from danger, or causing the vehicle to move away from the dangerous situation.

Since other modifications and changes varied to fit particular operating requirements and environments will be apparent to those skilled in the art, the invention is not considered limited to the example chosen for the purposes of disclosure, and covers all changes and modifications which do not constitute departures from the true spirit and scope of this invention.

Having thus described the invention, what is desired to be protected by a Letters Patent is presented in the appended claims.

What is claimed is:

1. A remote safety system (1) for use with a riding vehicle (100) having a battery (101) for providing power to a motor (103), said system having:
a) at least one transmitter (57) for transmitting a signal, the transmitter (57) being part of a portable remote control (50);
b) a receiver (107) for receiving and recognizing the signal from the transmitter (57),
c) a modification circuit (109) capable of modifying power being provided from the battery (101) to the motor (103), thereby affecting said vehicle's (100) operation;
d) an actuator (211), responsive to the receiver (107), for causing the modification circuit (109) to modify power being provided to motor (103) when the receiver (107) receives a modification signal.

2. The remote safety system (1) of claim 1, wherein the system (1) is a low power drain system which only drains power from battery (101) when the vehicle is being operated.

3. The remote safety system (1) of claim 1, wherein the modification circuit (109) comprises a relay which operates in one mode to cause power to be provided to motor (103), or operates in a second mode to restrict power from being provided to motor (103).

4. The remote safety system (1) of claim 1, wherein the modification circuit (109) comprises a cross-over bridge which reverses polarity of power provided to motor 103.

5. The remote safety system (1) of claim 1, wherein the modification circuit (109) comprises a variable resistor capable of variably reducing the power provided to motor 103.

6. The remote safety system (1) of claim 1, further comprising:
a manual reset device (213) for overriding the actuator (211) to manually reset modification circuit (109) causing modification circuit not to modify power provided to the motor (103).

7. The remote safety system (1) of claim 1, further comprising a deactivate button (51) on remote control (50), causing transmitter (57) to transmit a ‘stop’ signal when pressed, thereby causing receiver (107) to receive and decode the ‘stop’ signal, then causing the actuator (211) to cause modification circuit (109) to prevent power from being provided to motor (103).

8. The remote safety system (1) of claim 1, further comprising a slow button (61) on remote control (50), causing transmitter (57) to transmit a ‘slow’ signal when pressed, thereby causing receiver (107) to receive and decode the ‘slow’ signal, then causing the actuator (211) to cause modification circuit (109) to reduce the power being provided to motor (103).

9. The remote safety system (1) of claim 1, further comprising a reverse button (59) on remote control (50), causing transmitter (57) to transmit a ‘reverse’ signal when pressed, thereby causing receiver (107) to receive and decode the ‘reverse’ signal, then causing the actuator (211) to cause modification circuit (109) to reverse polarity of power being provided to motor (103).

10. The remote safety system (1) of claim 1, wherein said battery (101) is a rechargeable battery.

11. The remote safety system (1) of claim 1, further comprising an indicator light (55), the indicator light (55) indicating when the transmitter (57) is outside of range of receiver (107) thereby not being able to deactivate vehicle (100).

12. A method of protecting a rider on a riding vehicle (100) having a battery (101) powering a motor (103) through a switch (105) comprising the steps of:
a) providing a modification circuit (109) capable of restricting power supplied from said battery (101) to said motor (103);
b) providing a receiver (107) capable of receiving and recognizing at least one transmitted signal, and capable of operating said modification circuit (109) causing the modification circuit (109) to modify the amount of power supplied to said motor (103) when the modification signal is received; and
c) operating a remote transmitter (57) to transmit a modification signal to the receiver (107) causing receiver (107) to operate modification circuit (109) thereby modifying the power provided to motor (103).

13. The method of claim 12, further comprising the step of:
conserving power by only powering the modification circuit (109) when switch (105) is in a conducting mode.

14. The method of claim 12, further comprising the step of:
conserving power by only powering the receiver (107) when switch (105) is in a conducting mode.

15. The method of claim 12 wherein the modification signal is a ‘stop’ signal and the modification circuit (109) prevents power from flowing to the motor (103).

16. The method of claim 12 wherein the modification signal is a ‘slow’ signal and the modification circuit (109) reduces the power allowed to flow to the motor (103).

17. The method of claim 12 wherein the modification signal is a ‘reverse’ signal and the modification circuit (109) reverses polarity of power provided to the motor (103), thereby reversing vehicle (100).

18. A method of retrofitting a riding vehicle (100) having a battery (101) powering a motor (103) through a switch (105) for protecting a rider comprising the steps of:
a) adding a modification circuit (109) to said riding vehicle (100) capable of restricting power supplied from said battery (101) to said motor (103);
b) adding a receiver (107) to said riding vehicle (100) capable of receiving and recognizing at least one transmitted signal, and capable of operating said modification circuit (109) causing the modification circuit (109) to modify the amount of power supplied to said motor (103) when the modification signal is received; and
c) operating a remote transmitter (57) to transmit a modification signal to the receiver (107) causing receiver (107) to operate modification circuit (109) thereby modifying the power provided to motor (103).
